(19) United States
(12) Patent Application Publication
(10) Pub. No.: US 2007/0233373 A1
(43) Pub. Date: Oct. 4, 2007

(54) MAP SCALE CHANGING METHOD AND APPARATUS FOR NAVIGATION SYSTEM

(75) Inventors: Hyun-Woo CHOI, Seongnam-si (KR); Eun-Hee JEONG, Seoul (KR); Chae-Guk CHO, Yongin-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/671,253

(22) Filed: Feb. 5, 2007

(30) Foreign Application Priority Data
Feb. 3, 2006 (KR) 10-2006-0010549

(51) Int. Cl. G01C 21/00

(52) U.S. Cl. 701/209; 701/200

(57) ABSTRACT

A map scale changing method and apparatus for navigation system capable of automatically changing a map scale when a travel route of a mobile object is searched and displayed on a display screen, whereby a map scale is changed based on a distance between a current position of the mobile object and a search start position of the travel route when the mobile object starts to travel to allow both the current position of the mobile object and a start position of the travel route to be displayed a display screen, and a map scale is changed based on a distance between the current position of the mobile object and a real destination in case the mobile object approaches a search termination position of the travel route to allow both the current position and the destination to be displayed on the display screen.

### CROSS-REFERENCE TO RELATED APPLICATION

This application is based upon and claims the benefit of priority from the prior Korean Patent Application No. 10-2006-0010549, filed on Feb. 03, 2006, the entire contents of which are incorporated herein by reference.

### FIELD

This description relates to a map scale changing method and apparatus for navigation system.

### BACKGROUND

Concomitant with continuous increase of the number of mobile objects such as vehicles, traffic congestion has become more critical these days. Particularly, there is a serious problem in that the number of vehicles is increasing much faster than that of the supporting and necessary infrastructures, such as roads, bridges and the like. Navigation systems have been utilized as one of the solutions for traffic congestion.

The typical navigation system detects a current vehicle position using navigation messages transmitted by a plurality of Global Positioning System (GPS) satellites and detection signals of travel conditions of the vehicle detected by a plurality of sensors, such as gyroscopes and speed sensors, installed in the vehicle. When the current vehicle position is detected, the navigation system matches the detected current vehicle position to map data and then displays the current vehicle position on a display screen of a display unit together with a map. In addition, the navigation system provides the functionality of searching for a travel route of the vehicle from a start position to a destination using the map data, and guiding the vehicle along the travel route.

The navigation system receives the traffic information relative to each road from a traffic information center, uses the provided traffic information to search of the travel route and searches the travel route to enable a mobile object to reach a destination within a fastest time possible. Therefore, the typical navigation system is used to search for and navigate a vehicle along a travel route so that the user can effectively use given road networks by searching and guiding the travel route of the mobile object.

If the navigation system searches the travel route of the mobile object and guides the searched travel route, a pre-set map scale data for guiding the travel route is typically employed to display a map on a display screen of a display unit, and the displayed map is simultaneously shown with a current position and the searched travel route of the mobile object for guidance of the mobile object.

Typically, in searching a travel route of a mobile object, a position of a link nearest to a current position of the mobile object is determined as a search start position of the travel route, and a position of a link nearest to a destination is determined as a search termination position. The links existing between the search start position and the search termination position thus determined are searched for searching for the travel route.

In case of a university and a factory composed of large-scale research institutes or sprawling lots, only information of buildings is stored in a map data while information on a link on which a mobile object can travel between the buildings is not stored.

As a result, in case a particular building in a university and a factory composed of large-scale research institutes or sprawling lots is set up as an origin (a current position of a mobile object) or a destination of the mobile object, and a travel route is searched, a distance between the origin of the mobile object and a search start position on the travel route, and a distance between a search termination position on the travel route and the destination may be fairly distanced.

Under these circumstances, the conventional navigation system displays a map on a display screen based on a map data having a pre-set map scale regardless of a distance between the origin of the mobile object and the search start position, and guides the mobile object to the travel route. Furthermore, even if the mobile object approaches the search termination position, the navigation system displays the map on the display screen based on the map data having the pre-set map scale regardless of the distance between the current position and the destination of the mobile object and guides the mobile object to the travel route.

Such being the case, only the destination of the mobile object is displayed on the map of the display screen in case the distance between the origin and the search start position is fairly distanced, while the search start position on the travel route is not displayed, such that there is no knowing whether the mobile object is correctly traveling to a direction of the search start position if the mobile object is steered by a user.

Another problem is that only the current position and the search termination position of the mobile object are displayed on the map of the display screen even if the distance between the current position and the destination is fairly distanced while the mobile object has neared the search termination position, and the destination is not displayed, such that there is no knowing whether the mobile object is correctly traveling from the search termination position to a direction of the destination.

Under these circumstances, the user may adjust the map scale of the map displayed on the display screen to allow both the current position and the search start position, and the current position and the destination of the mobile object to be displayed on the display screen. However, in this case, the user has to suffer from a nuisance of manually manipulating an instruction input unit of the navigation system to adjust the map scale of the map.

### BRIEF DESCRIPTION OF THE DRAWINGS

FIG. 1 is a block diagram illustrating the configuration of a navigation system to which a map scale changing method for navigation system is applied.

FIG. 2 is a signal flowchart illustrating a map scale changing method.

FIG. 3 is a signal flowchart illustrating a search process of a travel route in FIG. 2.

FIG. 4 is a signal flowchart illustrating a map scale changing process at an origin of FIG. 2.

FIG. 5 is a signal flowchart illustrating a map scale changing process at a destination of FIG. 2.

### SUMMARY

One object is to provide a map scale changing method and apparatus for navigation system adapted to automatically change a map scale displayed on a display screen based on a distance between a current position of a mobile object and a search start position on a travel route to allow the current position of the mobile object and the search start position to be simultaneously displayed.

Another object is to provide a map scale changing method and apparatus for navigation system adapted to automatically change a map scale displayed on a display screen based on a distance between a current position of a mobile object and a destination to allow the current position of the mobile object and the destination to be simultaneously displayed when the mobile object approaches a search termination position on a travel route.

According to the map scale changing method for navigation system, a position of a link adjacent to an origin of a mobile object is determined as a search start position from which a travel route is to be searched. A position of a link adjacent to a destination of the mobile object is determined as a search termination position on which the search of the travel route is to be terminated. If the search start position and the search termination position are determined, the travel route between the search start position and the search termination position thus determined is searched.

Determination is made as to whether the current position of the mobile object and the search start position can be all displayed on a display screen along with the map using the map scale data for guiding the travel route when the mobile object starts to move. If the current position of the mobile object and the search start position cannot be all displayed on the display screen, a higher map scale data is selected to repeat an operation of determining whether the current position of the mobile object and the search start position can be all displayed on the display screen.

If a map scale data is selected capable of displaying all the current position of the mobile object and the search start position on the display screen, the current position of the mobile object and the search start position are displayed on the display screen along the map based on the selected map data to allow a user of the mobile object to correctly check a direction of the search start position and to travel the mobile object.

Furthermore, the navigation system guides the user to the travel route based on the map scale data capable of displaying all the current position of the mobile object and the destination if the mobile object approaches the search termination position having searched for the travel route to allow the mobile object to correctly travel to a direction of the destination from the search termination position.

In one general aspect, a map scale changing method for navigation system comprises: searching for a travel route of a mobile object; changing a map data that is used for guiding the travel route to a map scale data capable of displaying both a current position of the mobile object and a search start position on a display screen based on a distance between the current position of the mobile object and the search start position for starting the search for the travel route; continuing to guide the travel of the mobile object based on a map scale data for guiding the travel route if the map data used for guiding the travel route is a map scale data pre-set for guiding the travel route.

In another general aspect, a map scale changing method for navigation system comprises: searching for a travel route of a mobile object; guiding the mobile object to travel along the searched travel route using the map scale data pre-set for guiding the travel route; changing a map data that is used for guiding the travel route to a map scale data capable of displaying both a current position of the mobile object and a destination on a display screen and guiding the mobile object to the destination in case a distance between the mobile object and a search termination position for terminating the search is within a pre-set distance.

In another general aspect, a map scale changing method for navigation system comprises: searching for a travel route of a mobile object; changing a map data that is used for guiding the travel route to a map scale data capable of displaying both a current position of the mobile object and a search start position on a display screen based on a distance between the current position of the mobile object and the search start position for starting the search for the travel route; continuing to guide the travel of the mobile object based on a map scale data for guiding the travel route if the map data used for guiding the travel route is a map scale data pre-set for guiding the travel route; changing the map data that is used for guiding the travel route to the map scale data capable of displaying both the current position of the mobile object and the destination on the display screen and guiding the mobile object to the destination in case a distance between the mobile object and the search termination position for terminating the search is within a pre-set distance while guiding the mobile object based on the map scale data for guiding the travel route.

In another general aspect, a map scale changing apparatus for navigation system comprises: a GPS (Global Positioning System) receiver for receiving navigation messages; a map data storage for storing a plurality of map scale data; a control unit for searching for a travel route of a mobile object, determining a current position of the mobile object based on the navigation messages received by the GPS receiver, changing a map data that is used for guiding the travel route to a map scale data capable of displaying a current position of the mobile object and a search start position on a display screen and guiding the searched travel route, and continuing to guide the travel of the mobile object based on the map scale data for guiding the travel route if the map data used for guiding the travel route is a map scale data pre-set for guiding the travel route.

### BRIEF DESCRIPTION OF THE DRAWINGS

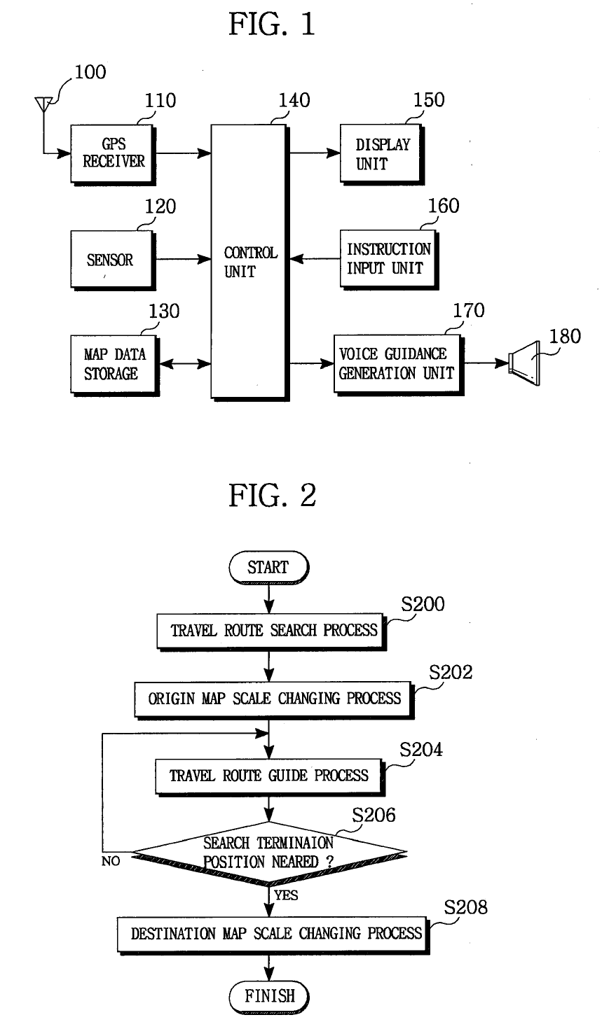

FIG. 1 is a block diagram illustrating the configuration of a navigation system to which a map scale changing method for navigation system is applied.

FIG. 2 is a signal flowchart illustrating a map scale changing method.

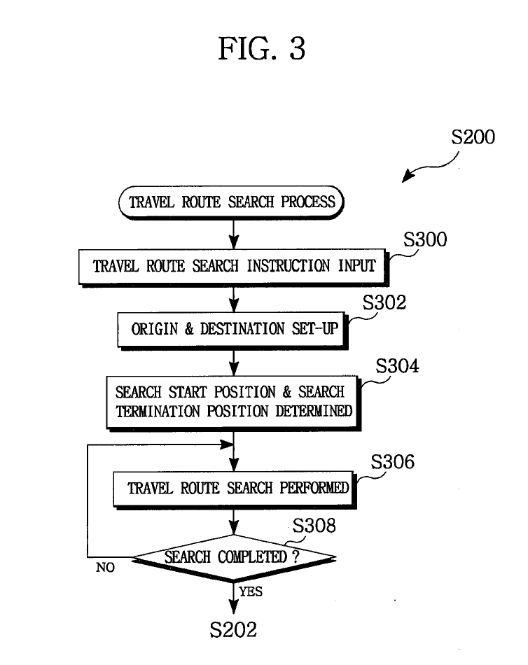

FIG. 3 is a signal flowchart illustrating a search process of a travel route in FIG. 2.

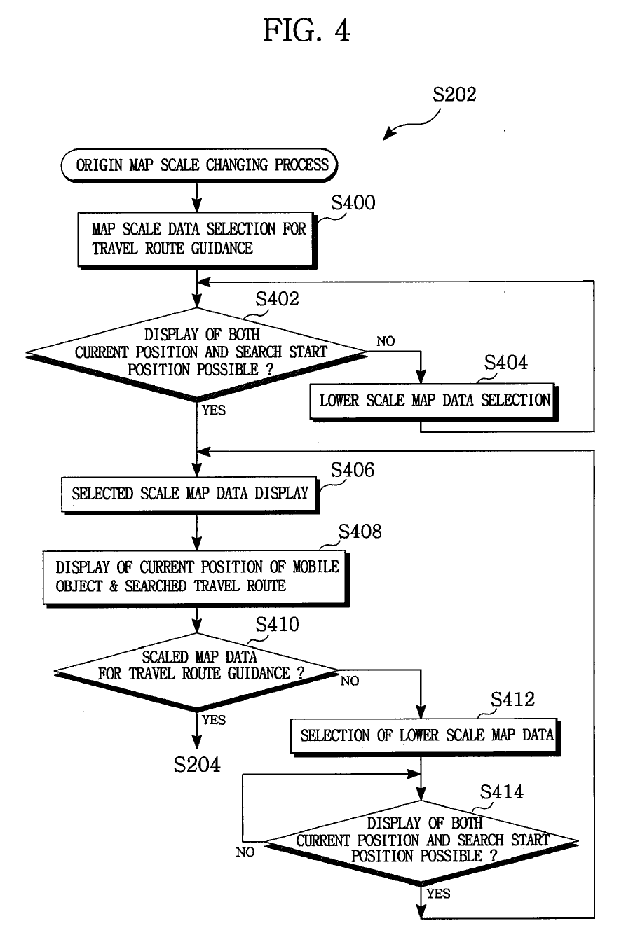

FIG. 4 is a signal flowchart illustrating a map scale changing process of an origin of FIG. 2.

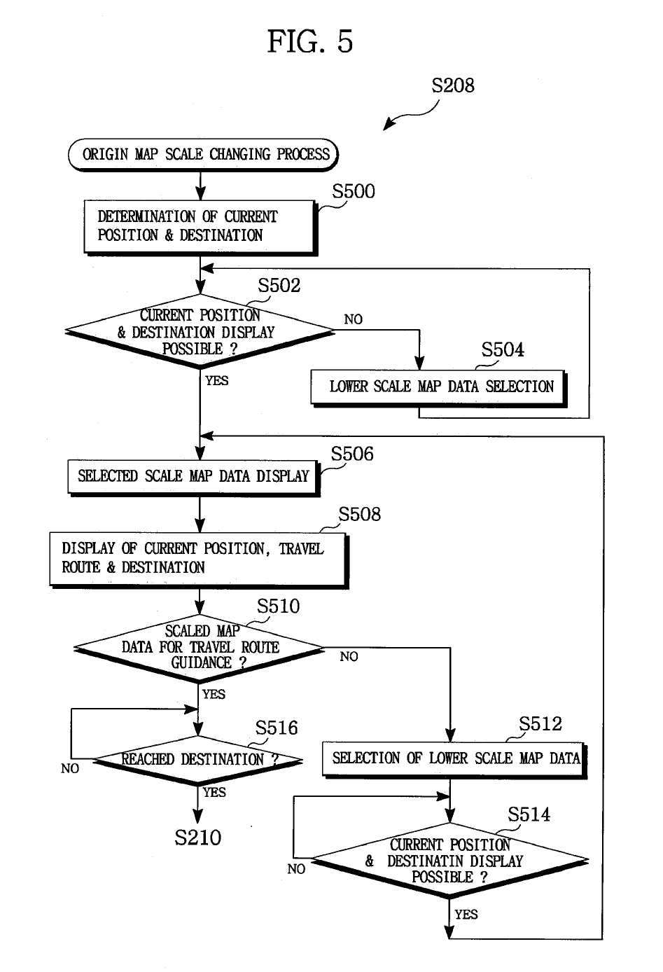

FIG. 5 is a signal flowchart illustrating a map scale changing process of a destination of FIG. 2.

### DETAILED DESCRIPTION

It should be understood that this description hereunder is to be regarded in an illustrative rather than a restrictive sense. Therefore, the principle and concept of implementations are provided with a view to explaining in useful and easy manner. As a result, no more detailed structure than is necessary for basic understanding is provided, and various configurations that can be exploited in reality by those skilled in the art are to be exemplified through the accompanying drawings.

FIG. 1 is a block diagram illustrating the configuration of a navigation system to which a map scale changing method for navigation system is applied. Referring to FIG. 1, reference numeral 100 defines an antenna, and reference numeral 110 represents a GPS receiver. The GPS receiver (110) receives navigation messages transmitted by a plurality of GPS satellites (not shown) through the antenna (100). In addition, the GPS receiver (110) calculates a DOP (Dilution of Precision) value indicating the reliability of the received navigation messages and outputs the calculated value. The DOP value is low if the navigation messages are reliable in a current position of a mobile object, but is high if the navigation messages are unreliable.

Reference numeral 120 is a sensor unit having a gyroscope for detecting a traveling angle of a mobile object and a variety of sensors, such as a speed sensor for detecting a travel speed of the mobile object and the like. The sensor unit (120) outputs signals indicative of the travel conditions of the mobile object.

Reference numeral 130 is a map data storage unit which is stored beforehand with a map data for searching for and guiding a travel route of the mobile object. For example, the map data storage unit (130) is stored with a map scale data for searching for the travel route of the mobile object, a map scale data for guiding the travel route of the mobile object and a plurality of map data, each having a different scaled map.

Reference numeral 140 is a control unit. The control unit (140) displays on a display screen of a display unit (150) an instruction input unit (160) which is a GUI (Graphic User Interface) for allowing a user to manipulate the navigation system using an OSD (On Screen Display).

Furthermore, the control unit (140) receives an origin and a destination of the mobile object from the instruction input unit (160) in case a search instruction of a travel route is inputted from the instruction input unit (160), and searches for the travel route between the inputted origin and the destination. The origin of the mobile object may be established as a current position of the mobile object determined by the control unit (140) using only the navigation messages received by the GPS receiver (110).

The control unit (140) may determine the current location of the mobile object through hybrid navigation using navigation messages received by the GPS receiver (110) and a travel status detection signal of the mobile object detected by a sensor.

In other words, a navigation system is such that at least four or more navigation messages are received by a Global Positioning System (GPS) receiver out of navigation messages periodically transmitted by a plurality of GPS satellites arranged on geostationary orbits over the Earth to detect 3D location coordinates of a mobile object, and a DOP (Dilution of Precision) value is calculated based on the received navigation messages.

The DOP value is low if the navigation messages are reliable in the current position of the mobile object, but is high if the navigation messages are unreliable. In other words, the DOP is a parameter that indicates the probabilities of measured coordinates based on geometric configurations of used satellites with regard to a mobile object. For example, if the GSP satellites are evenly arranged based on the position of a GSP receiver, the DOP value is low, while the DOP value is high if the GSP satellites are not uniformly arranged. The control unit (140) determines the reliability of the navigation messages by comparing a pre-set threshold value with the DOP value outputted by the GPS receiver (110).

If it is determined that the navigation messages are reliable, the control unit (140) detects the current vehicle location using the navigation messages. If it is determined that the navigation messages are unreliable, the control unit (140) detects the current position of the mobile object through the hybrid navigation that detects the current position from the final position of the mobile object detected with the reliable navigation messages by using the detection signals of travel conditions detected by the sensor unit (120). The current position of the mobile object detected by the hybrid navigation may be established as the origin of the mobile object.

The search of the travel route is performed in such a manner that the control unit (140) establishes positions of links nearest to the origin and destination of the mobile object as a search start position and a search termination position, and links existing between the established search start position and the search termination position are searched to search for the travel route.

If the search for the travel route has been completed, the control unit (140) selects a map scale data capable of displaying both the current position of the mobile object and the search start position on the display screen of the display unit (150). A map encompassing a region covering the current position of the mobile object and the search start position is displayed on the display screen of the display unit (150) using the selected map data, and the current position of the mobile object and the search start position, and the searched travel route are displayed on the map to thereby guide the travel route of the mobile object.

When the mobile object travels, the control unit (140) determines whether both the current position of the mobile object and the search start position can be displayed on the display screen of the display unit (150) using a map scale data of one scale lower than that of the map scale data for guiding the current travel of the mobile object, and if it is determined that both the current position of the mobile object and the search start position can be displayed using the lower map scale data, operation of guiding the travel of the mobile object is repeated using the lower map scale data.

Under this circumstance, if both the current position of the mobile object and the search start position can be displayed on the display screen of the display unit (150) using the pre-set map scale data for guiding the travel route, the map scale data for guiding the travel route is continuously used to guide the travel of the mobile object.

Furthermore, if voice guidance is necessitated due to the mobile object's turning left or right while being guided to the travel route, the control unit (140) controls a voice guidance generation unit (170) to create a voice guidance signal and outputs the created voice guidance signal to a speaker (180) to enable a user to listen thereto.

If the mobile object approaches the search termination position within a pre-set distance of 100˜200 meters, the control unit (140) determines whether both the current position of the mobile object and the destination can be displayed on the display screen of the display unit (150) using the map data employed for travel guidance of the mobile object.

As a result of the determination, if both the current position of the mobile object and the destination cannot be displayed on the display screen of the display unit (150), the control unit (140) selects a map scale data capable of displaying both the current position of the mobile object and the destination to continue guiding the travel route of the mobile object.

Under this circumstance, the control unit (140) determines whether both the current position of the mobile object and the destination can be displayed on the display screen of the display unit (150) using the map scale data of one scale lower than that of the map scale data for guiding the travel of the mobile object, and if it is determined that the current position of the mobile object and the destination can be displayed on the display screen of the display unit (150) using the map scale data of one scale lower than that of the map scale data, operation of guiding the mobile object using the map scale data of one scale lower is repeated.

If both the current position of the mobile object and the destination can be displayed on the display screen of the display unit (150) using the pre-set map scale data for guiding the travel route, the map scale data for guiding the travel route continues to be used to allow the mobile object to be guided for the travel of the mobile object to the destination.

FIG. 2 is a signal flowchart illustrating a map scale changing method for navigation system. Referring to FIG. 2, the control unit (140) performs the travel route search process from the origin or the current position of the mobile object to the destination (S200).

In the travel route search process (S200), a search instruction of the travel route is first inputted to the control unit (140) via the instruction input unit (160) (S300), as shown in FIG. 3.

Once the search instruction of the travel route is inputted, the control unit (140) establishes an origin and a destination of the mobile object (S302). The origin of the mobile object may be established as the current position of the mobile object determined by the control unit (140) using only the navigation messages received by the GPS receiver (110). The origin may be established as the current position discriminated by the controller (140) through the mixed navigation method using navigation messages received by the GPS receiver and the travel status detection signal of the mobile object detected by the sensor.

Once the origin and the destination are set up, the control unit (140) establishes positions of links nearest to the origin and destination of the mobile object as the search start position and a search termination position (S304), and searches for a travel route between the search start position and the search termination position (S306).

The control unit (140) then determines whether the search for the travel route has been completed (S308). As a result of the determination, if it is determined that the search for the travel route has not been completed, the control unit (140) repeats the operation of searching for the travel route between the search start position and the search termination position (S306). If it is determined that the search for the travel route has been completed, the travel route search process (S200) is terminated, and

The map scale changing process at the origin (S202) is performed.

The map scale changing process at the origin (S202) is implemented in such a fashion that in case the search for the travel route is completed, and the mobile object travels, a scale of the map is changed according to a distance between the current position of the mobile object and the search start position to guide the travel route of the mobile object.

Now, referring to FIG. 4, the control unit (140) first selects a map scale data pre-set for guide of the travel route, displays the selected map data on the display screen of the display unit (150) and determines whether both the current position of the mobile object and the search start position of the travel route can be displayed on the screen (S402).

As a result of the determination, if it is determined that both the current position of the mobile object and the search start position of the travel route cannot be displayed on the screen, the control unit (140) selects a map scale data having a scale lower than that of the selected map data (S404), and repeats an operation of determining whether both the current position of the mobile object and the search start position of the travel route can be displayed on the screen (S402).

By the repeated operation, once a map scale data capable of displaying both the current position of the mobile object and the search start position of the travel route on the screen is selected, the control unit (140) displays the map on the display screen of the display unit (150) using the selected map data (S406), and displays the current position of the mobile object and the searched travel route on the displayed map (S408).

At this time, the control unit (140) detects the current position of the mobile object based on the hybrid navigation method according to the travel of the mobile object, and the detected current position of the mobile object is displayed, whereas the displayed current position of the mobile object varies in response to the travel of the mobile object.

Under this circumstance, the control unit (140) determines whether the travel of the mobile object is being guided by the map scale data established for guide of the current position (S410).

As a result of the determination, if it is determined that the travel of the mobile object is not being guided by the map scale data established for guide of the current position, the control unit (140) selects a map data having a scale lower than that of the currently used map data for the guide of the travel route of the mobile object (S412). The control unit (140) determines whether both the current position of the mobile object and the search start position of the travel route can be displayed on the display screen of the display unit (150) using the selected map data a scale lower than the currently used map data (S414).

As a result of the determination, if it is determined that both the current position of the mobile object and the search start position of the travel route cannot be displayed on the screen, the control unit (140) repeats an operation of determining whether both the current position of the mobile object and the search start position of the travel route can be displayed on the screen (S402) using the selected lower map scale data (S414).

If it is determined that both the current position of the mobile object and the search start position of the travel route can be displayed on the screen using the selected lower map scale data, the control unit (140) displays a map on the screen of the display unit (150) using the selected lower map scale data (S406), displays the current position of the mobile object and the searched travel route on the displayed map (S408), and repeats an operation of determining whether the travel route is being guided based on the pre-set map scale data for guiding the travel route (S410).

Under this circumstance, if the travel route is being guided based on the pre-set map scale data for guiding the travel route, the control unit (140) terminates the map scale changing process at the origin (S202) and performs the travel route guide process (S204). The travel route guide process (S204), which allows a mobile object to travel along a searched travel route, will be omitted in its detailed operation as it is the same as that of the typical navigation system.

Successively, the control unit (140) determines (S206) whether the mobile object has approached the search termination position of the travel route of the mobile object while performing the travel route guide process (S204). For example, the control unit (140) determines whether the mobile object has approached the search termination position within a pre-set distance of 100˜200 meters.

As a result of the determination, if it is determined that the mobile object has not approached the search termination position within a pre-set distance of 100˜200 meters, the control unit (140) keeps performing the travel route guide process (S204) and repeats an operation of determining whether the mobile object has approached the search termination position (S206).

If it is determined that the mobile object has approached the search termination position, the control unit (140) performs a map scale changing process at the destination (S208). The map scale changing process at the destination (S208) is such that when the mobile object has approached the search termination position of the travel route, the map scale is changed based on the distance between the current position of the mobile object and the destination to guide the mobile object along the travel route to the destination.

Now, referring to FIG. 5, the control unit (140) determines the current position and the destination of the mobile object (S500). The control unit (140) then determines whether both the determined current position and the destination of the mobile object can be displayed on the display screen of the display unit (150) using the map data employed for guiding the travel route of the mobile object (S502).

If both the determined current position and the destination cannot be displayed on the display screen, the control unit (140) selects a map data of a scale lower than that of the map data used for guiding the travel route of the mobile object (S504), and repeats an operation of determining whether both the current position and the destination of the mobile object can be displayed on the screen based on the higher map scale data (S502).

Once the map scale data capable of displaying both the current position and the destination of the mobile object is selected by the process thus described, the control unit (140) uses the selected map data to display the map on the screen of the display unit (150) (S506), and displays the current position, the searched travel route and the destination of the mobile object on the displayed map (S508).

Under this circumstance, the control unit (140) determines whether the mobile object is being guided by the map scale data pre-set for guide of the mobile object (S510).

If it is determined that mobile object is not being guided by the map scale data pre-set for guide of the mobile object, the control unit (140) selects a map data having a scale lower than that of the currently used map data for the guide of the travel route of the mobile object (S512). The control unit (140) then determines whether both the current position and the destination of the mobile object can be displayed on the screen of the display unit (150) using the selected lower map scale data (S514).

If it is determined that both the current position and the destination of the mobile object cannot be displayed on the screen of the display unit (150), the control unit (140) repeats an operation of determining whether both the current position and the destination of the mobile object can be displayed on the screen based on the selected lower map scale data (S414).

If it is determined that both the current position and the destination of the mobile object can be displayed on the screen using the selected lower map scale data, the control unit (140) displays a map on the display screen of the display unit (150) using the selected lower map scale data (S506), displays the current position, the searched travel route and destination of the mobile object on the displayed map (S508), and repeats an operation of determining whether the mobile object is being guided by the map scale data pre-set for the guide of the mobile object along the travel route (S510).

Under this circumstance, if the mobile object is being guided by the map scale data pre-set for the guide of the mobile object along the travel route, the control unit (140) determines whether the mobile object has arrived at the destination (S516), and terminates the operation of guiding the mobile object along the travel route if the mobile object has reached the destination (S210).

The description described above has focused on exemplary embodiments where a mobile object is guided to a destination along a travel route using a map scale data capable of displaying both a current position and the destination of the mobile object when the mobile object has approached a search termination position within a predetermined distance. The description is not limited thereto but various modifications may be implemented that include but not limited to a case where a mobile object can be guided to a destination using a map scale data capable of displaying both a current position and a destination of the mobile object when the mobile object has reached the destination within a predetermined distance.

As apparent from the foregoing, a mobile object is guided along a travel route by selecting a map scale data capable of displaying both a current position of the mobile object and a search start position of the travel route when the travel route of the mobile object is searched and the mobile object starts to travel.

Therefore, a user can simultaneously ascertain the current position and the search start position of the mobile object displayed on a screen when the mobile object starts to travel, and can correctly steer the mobile object to a direction of the search start position along the travel route.

Furthermore, a map scale data capable of displaying both the current position and the destination of the mobile object can be selected for guidance of the mobile object along the travel route when the mobile object nears a termination position of the travel route.

The user therefore can ascertain the current position and destination of the mobile object displayed on the map and correctly steer the mobile object to a direction of destination when the mobile object reaches the termination position of the travel route.

While there has been illustrated and described what is presently contemplated to be implementations of this description, it will be understood by those skilled in the art that various changes and modifications may be made, and equivalents may be substituted for elements thereof without departing from the true scope of the foregoing description. In addition, many modifications may be made to adapt a particular situation to the teachings of this description without departing from the central scope thereof. Therefore, it is intended that the above-described implementations not be limited to the particular ones disclosed, but that this description will include all implementations falling within the scope of the appended claims.

What is claimed is:

1. A navigation system for guiding a subject from a start position to a destination position, the system comprising:
a position detector configured to detect a current position of the subject;
a memory unit configured to store map data;
a display unit; and
a control unit configured to display a map on the display unit based on the map data, wherein the control unit is configured to adjust a scale of the map displayed on the display unit based on a current position of the subject.

2. The system of claim 1, wherein the control unit is configured to adjust the scale of the displayed map while the subject is traveling from the start position to the destination position.

3. The system of claim 1, wherein the control unit is configured to adjust the scale of the displayed map based on a distance between the current position of the subject and the start position.

4. The system of claim 3, wherein the control unit is configured to adjust the scale of the displayed map to show both the current position of the subject and the start position on the displayed map.

5. The system of claim 1, wherein the control unit is configured to adjust the scale of the displayed map based on a distance between the current position of the subject and the destination position.

6. The system of claim 5, wherein the control unit is configured to adjust the scale of the displayed map to show both the current position of the subject and the destination position on the displayed map.

7. A map scale changing method for a navigation system comprising:
searching for a travel route of a mobile object;
changing a map data that is used for guiding the travel route to a map scale data capable of displaying both a current position of the mobile object and a search start position on a display screen based on a distance between the current position of the mobile object and the search start position for starting the search for the travel route;
continuing to guide the travel of the mobile object based on a map scale data for guiding the travel route if the map data used for guiding the travel route is a map scale data pre-set for guiding the travel route.

8. The method as claimed in claim 7, wherein the search of the travel route comprises:
establishing an origin and a destination in response to a search instruction of the travel route;
determining the search start position and a search termination position for searching for the travel route based on the established origin and the destination; and
searching for the travel route between the determined search start position and the search termination position.

9. The method as claimed in claim 8, wherein the search start position and the search termination position are positions of links nearest to the origin and destination of the mobile object, respectively.

10. The method as claimed in claim 8, wherein the origin of the mobile object is a position determined by the control unit based on a hybrid navigation using navigation messages received by a Global Positioning System (GPS) receiver and a travel status detection signal of the mobile object detected by a sensor.

11. The method as claimed in claim 7, wherein the map data changing comprises:
selecting and displaying a map scale data capable of displaying both the current position of the mobile object and the search start position on a display screen;
displaying the current position of the mobile object and the searched travel route on the map displayed on the screen; and
repeating an operation of guiding the travel of the mobile object based on a map data having a scale lower than that of the map scale data that is shown with the map.

12. The method as claimed in claim 7, wherein the current position of the mobile object is a position determined by a control unit through a hybrid navigation using navigation messages received by a Global Positioning System (GPS) receiver and a travel status detection signal of the mobile object detected by a sensor.

13. A map scale changing method for a navigation system comprising:
searching for a travel route of a mobile object;
guiding travel of the mobile object along the searched travel route using a map scale data pre-set for guiding the travel route; and
changing the map data that is used for guiding the travel route to a map scale data capable of displaying both a current position and a destination of the mobile object on a display screen and guiding the mobile object to the destination if a distance between the mobile object and a search termination position for terminating the search is within a pre-set distance.

14. The method as claimed in claim 13, wherein the map data changing comprises:
guiding the travel route of the mobile object based on the map scale data capable of displaying both the current position and the destination of the mobile object when the mobile object has approached the search termination position within a pre-set distance; and
guiding the mobile object based on a map data having a scale lower than that of the map scale data for guiding the travel route of the mobile object if the lower scale map data is capable of displaying both the current position and the destination of the mobile object on the display screen.

15. The method as claimed in claim 13, wherein the current position of the mobile object is a position determined by a control unit through a hybrid navigation using navigation messages received by a Global Positioning System (GPS) receiver and a travel status detection signal of the mobile object detected by a sensor.

16. A map scale changing method for a navigation system comprising:
searching for a travel route of a mobile object;
guiding the mobile object to travel along the searched travel route based on a pre-set map scale data for guiding the travel route; and
changing to a map scale data capable of displaying both a current position and a destination of the mobile object and guiding the mobile object to the destination, if the mobile object approaches the destination within a pre-set distance.

17. The method as claimed in claim 16, wherein the search for the travel route comprises establishing positions of links nearest to an origin and the destination as a search start position and a search termination position to search for a travel route between the search start position and the search termination position.

18. The method as claimed in claim 16, wherein the changing of map scale data capable of displaying both the current position and the destination of the mobile object on the display screen comprises:
guiding the travel route of the mobile object by changing to a map scale data capable of displaying both the current position and the destination of the mobile object, if the mobile object approaches a search termination position that has terminated the search for the travel route of the mobile object within a pre-set distance; and
guiding the travel route of the mobile object based on a map data having a scale lower than that of the map scale data for guiding the travel route of the mobile object, if both the current position and the destination of the mobile object can be displayed on the display screen based on the map data having a scale lower than that of the map data for guiding the travel route of the mobile object.

19. A map scale changing apparatus for a navigation system comprising:
a GPS (Global Positioning System) receiver for receiving navigation messages;
a map data storage for storing a plurality of map scale data; and
a control unit for searching for a travel route of a mobile object, determining a current position of the mobile object based on the navigation messages received by the GPS receiver, changing a map data that is used for guiding the travel route to a map scale data capable of displaying a current position of the mobile object and a search start position on a display screen and guiding the searched travel route, and continuing to guide the travel of the mobile object based on the map scale data for guiding the travel route if the map data used for guiding the travel route is a map scale data pre-set for guiding the travel route.

20. The apparatus as claimed in claim 19, further comprising a sensor for detecting the travel route of the mobile object, wherein the control unit determines the current position of the mobile object through a hybrid navigation using navigation messages received by a Global Positioning System (GPS) receiver and an output signal of the sensor.

21. The apparatus as claimed in claim 19, wherein the control unit guides the travel route of the mobile object by changing to a map scale data capable of displaying both the current position and a destination of the mobile object, if the mobile object approaches a search termination position that has terminated the search for the travel route of the mobile object within a pre-set distance.

22. The apparatus as claimed in claim 19, wherein the control unit guides the travel route of the mobile object by changing to a map scale data capable of displaying both the current position and a destination of the mobile object, if the mobile object approaches a search termination position that has terminated the search for the travel route of the mobile object within a pre-set distance, and wherein the control unit guides the travel route of the mobile object based on a lower map scale data, if both the current position and the destination of the mobile object can be displayed on a display screen based on the map data having a scale lower than that of the map data for guiding the travel route of the mobile object.
